(19) United States
(12) Patent Application Publication
(10) Pub. No.: US 2017/0228915 A1
(43) Pub. Date: Aug. 10, 2017

(54) Generation Of A Personalised Animated Film

(71) Applicant: Worou CHABI, Clichy (FR)

(72) Inventor: Worou CHABI, Clichy (FR)

(21) Appl. No.: 15/514,685

(22) PCT Filed: Sep. 24, 2015
(86) PCT No.: PCT/FR2015/052556

§ 371 Date: Mar. 27, 2017

(30) Foreign Application Priority Data
Sep. 25, 2014 (FR) 1459055

(51) Int. Cl. G06T 13/80; G06T 11/00; G06T 19/20; G06T 13/40; G06T 15/02

(52) U.S. Cl. CPC G06T 13/80; G06T 13/40; G06T 15/02; G06T 19/20; G06T 11/001

(57) ABSTRACT

Method of generating a personalized animation film, which method is carried out by informatic means, comprised of receiving a photograph, in digital form, displaying at least one personalized pattern; associating the at least one personalized pattern with a basic pattern which is part of a set of basic patterns which have been previously stored; and generating an animation film from the at least one personalized pattern, the associated basic pattern, and a scenario comprised of a pre-defined environment.

The invention relates to generation of a personalized animation film.

The term “animation film” refers to a film realized from a sequence of images. An animation film may be static or dynamic, depending on the sequence of images.

A drawback of current animation films is that they cannot generally be adapted to the desires or preferences of the user.

Methods of “augmented reality” are known which allow one to superpose a virtual model over the normal perception which we have of reality, in real time. However, these methods do not allow the creator or realizer to manage the scenario of the video which is generated, because the scenario itself is a function of a real scene filmed in real time by the user.

Thus there exists a need for methods, and systems, which enable one to generate a personalized animation film, based on a pre-established scenario, in a manner sufficiently simple to be accessible to a user having little or no knowledge of informatics. The present invention serves to improve the situation.

Toward this end, the invention proposes a method of generating a personalized animation film, which method is carried out by informatic means, and is characterized in that it is comprised of steps as follows:
(1) Receiving a photograph, in digital form, displaying at least one personalized pattern;
(2) Associating the at least one personalized pattern with a basic pattern which is part of a set of basic patterns which have been previously stored; and
(3) Generating an animation film from: the at least one personalized pattern, the associated basic pattern, and a scenario comprised of a pre-defined environment.

According to embodiments of the invention, the at least one personalized pattern is realized from a basic pattern from the set of basic patterns.

The pre-defined environment may be comprised of virtual elements which have been previously stored.

Step (2) may be comprised of an operation comprising:

(2.1) Identifying the basic pattern associated with the personalized pattern.

The method of generating a personalized animation film may further be comprised of a step comprising receiving at least one identifier of at least one basic pattern, to be associated with at least one personalized pattern which is visible in the view. The operation (2.1) is then carried out from a subset of the set of basic patterns, which subset is determined using the at least one identifier which has been received.

According to embodiments of the invention, the photograph shows at least one identifier.

The operation (2.1) may comprise a sub-operation comprising detecting a border around the personalized pattern. The basic pattern is then identified from the position of the border.

The animation film generated may also be a function of a preceding photograph used for a previous iteration of steps (1) to (3).

The invention further proposes an informatic program comprising instructions for carrying out the above-described method, which program is executed by a processor.

The invention also proposes a system for generating a personalized animation film, comprised of:
Receiving means, configured to receive a photograph in digital form, which photograph displays at least one personalized pattern;
Means for association, configured to associate the at least one personalized pattern with a basic pattern which is part of a set of basic patterns which have been previously stored; and
Means for generating an animation film, configured to generate an animation film from: the at least one personalized pattern, the associated basic pattern, and a scenario comprised of a pre-defined environment.

Additional characteristics and advantages of the invention will be apparent from reading the following description. That description is purely illustrative, and is presented with reference to the accompanying drawings.

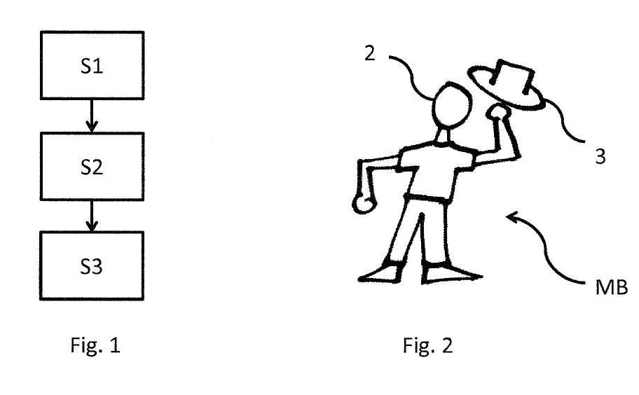

FIG. 1 is a flow chart, which illustrates the steps of a method of generating a personalized animation film according to a first embodiment of the invention;

FIG. 2 is a view of an example of a basic pattern;

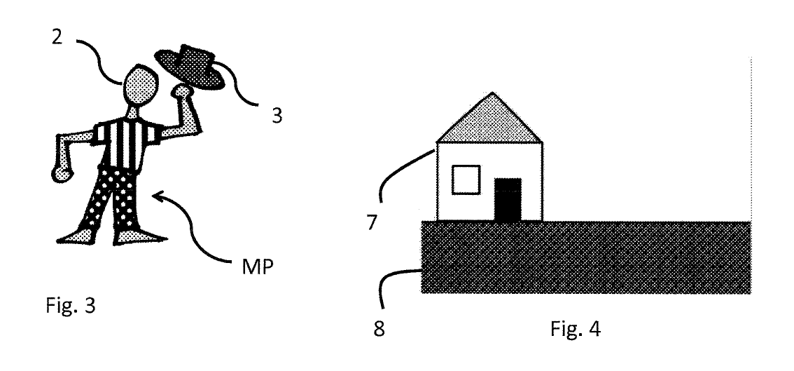

FIG. 3 is a view of an example of a personalized pattern obtained from the basic pattern according to FIG. 2;

FIG. 4 is a view of an example of a pre-defined environment;

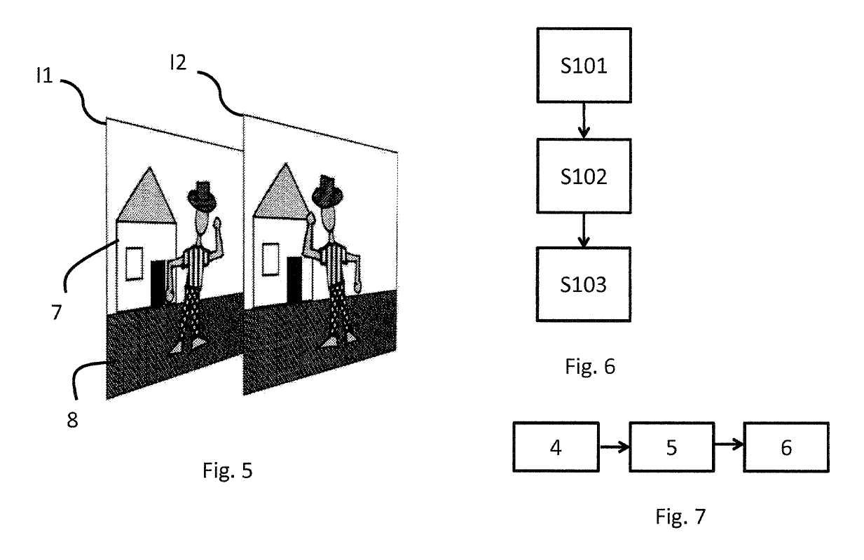

FIG. 5 is a view of an example of a sequence of images from an animation film generated from the basic pattern of FIG. 2, the personalized pattern of FIG. 3, and a scenario comprised of the predefined environment according to FIG. 4;

FIG. 6 is a flow diagram illustrating the steps of the method of generating a personalized animation film according to a second embodiment of the invention; and

FIG. 7 is a block diagram illustrating a system for generating a personalized animation film according to an embodiment of the invention.

FIG. 1 illustrates the steps of a method of generation of a personalized animation film, according to a first embodiment of the invention.

The method is intended to be implemented via informatic means, such as a computer, e.g. via the informatic system 1 in FIG. 6. The system 1 may be comprised of one or more devices, e.g. a server, a desktop computer, a portable computer, a smart phone, and/or a tablet computer. If the system 1 is comprised of a plurality of devices, the different devices are configured so as to be able to intercommunicate, e.g. with the use of the Internet network.

The method is comprised of the following:
a step S1 of receipt of a photograph;
a step S2 of association of a personalized pattern MP with a basic pattern MB; and
a step S3 of generation of an animation film.

In the step S1, a photograph, in digital form, is received by the system 1.

For example, the photograph is received in the form of a matrix of triplets of numbers, representing the components red, green, and blue of the color of each pixel.

The photograph may be obtained, e.g., from a view which constitutes an instant image. Alternatively, it may be obtained from a sequence of images captured by a camera. Further, it is not necessary that the photograph be a real life photograph, but rather it may be synthesized artificially. Also, the photograph may have been modified before being received.

The photograph displays one or more personalized patterns MP.

According to a first embodiment of the invention, each personalized pattern MP is personalized, starting with a basic pattern MB which is part of a collection of basic patterns which has been previously stored.

A basic pattern MB is defined by a collection of data which allows it to be characterized. For example, it may comprise data relating to a predefined rectangular image, characterized by its proportions, its graphic content, and/or its “aspect” (two dimensional or three dimensional). It may also comprise data relating to a graphic signature.

The graphic content of a basic pattern MB is defined by, e.g., its proportions and its contours.

The term “contours” is used to represent the collection of lines or surfaces which defines the graphic content of a pattern.

Here, preferably, the basic pattern is personalized by means of modifications applied to a non-informatic physical support, e.g. a coloring sheet.

As an example, FIG. 2 illustrates a basic pattern MB which represents a particular character 2 with his hat 3.

Each personalized pattern MP is the result of, e.g. coloring of the associated basic pattern MB, and/or of addition of a drawing to the associated basic pattern MB, and/or of modification of an element of the associated basic pattern MB.

As an example, FIG. 3 illustrates a personalized pattern MP obtained from the basic pattern according to FIG. 2.

In the case of a drawing added to the basic pattern MB, it will be “interpreted” in the subsequent steps of the method. Thus in this case the creation of the drawing is guided, e.g., by an instruction given to the user, of the type of “draw a star”.

The element of the base pattern MB which can be altered is for example a box (not shown), which the user can decide to check.

Each personalized pattern MP may be surrounded by a border (not shown) provided on the associated base pattern MB. The border is formed, e.g., by a black rectangle having a thicker contour than the elements of the base pattern MB.

The step S1 may further comprise an operation consisting of receiving one or more identifiers. Each identifier received identifies a base pattern MB associated with a personalized pattern MP which might be visible in the photograph.

The identifier(s) may be transmitted by the user independently of the photograph.

In a variant, the photograph may display, in addition to the personalized pattern(s) MP, one or more identifiers. The identifier(s) can be directly encoded in the border, for example. The receipt of the identifier(s) is then carried out by means of an image analysis.

It is important to note that the number of personalized patterns visible in the photographs is not necessarily equal to the number of identifiers received. The photograph may display a plurality of personalized patterns MP, with the system receiving only one identifier (e.g. because the scenario of the film only contemplates one identifier). Conversely, a plurality of identifiers may be received even though only one personalized pattern MP is visible in the photograph (e.g. as a result of framing of the photograph.

In step S2, the personalized pattern MP is associated with a basic pattern MB.

This association consists in particular of searching among the basic patterns MB previously stored, to find a basic pattern which corresponds to the personalized pattern MP to be analyzed. Stated otherwise, it is sought to retrieve the identifier of the basic pattern MB associated with the personalized pattern MP, under circumstances where that identifier may or may not have been received.

If no identifier has been received by the system 1, it may be necessary to search for the basic pattern MB from among all of the basic patterns MB which have been stored.

If a plurality of identifiers has been received, e.g. because a predefined scenario of the animation film implies that a plurality of personalized patterns MP will be visible in the photograph, it is possible to search for the basic pattern MB only from among a subset of the basic patterns MB which have been stored. The subset corresponds to the basic patterns MB associated with the identifiers which have been received.

If only a single identifier has been received, the subset used for the search may comprise only a single basic pattern MB.

If the photograph displays a plurality of personalized patterns MP, the operations of the type of S2 are repeated in a similar manner, for each personalized pattern MP.

The step S2 comprises an operation of detection, consisting of finding the position of the at least one personalized pattern MP in the photograph.

The step S2 further comprises an operation of canonical forming. This operation consists of passing from a personalized pattern MP detected to a personalized pattern MP in a canonical form.

In general, the term “canonical forming” designates a method in which data having a plurality of possible representations are converted into a standard format. It is used in particular in order to be able to make logical comparisons, to improve the efficiency of certain algorithms by eliminating unnecessary evaluations, or to make it possible to order elements according to their meaning.

A pattern which is detected has a known position in the photograph; further, it appears there with a certain perspective and a certain amount of deformation related to the photographing.

A canonically formed pattern is a detected pattern which has been converted (brought back) to a predefined projection. For example, a planar (two-dimensional) pattern, in a perspective view, is canonically formed when it is represented in an orthographic view (orthographic projection).

Canonical forming may be realized by an affine transformation, if the pattern is planar.

The step S2 comprises, in addition, an operation of “decolorization”, which consists of suppressing (or deleting) (while retaining them in the memory) the personalized characteristics (or “layout”) of the personalized pattern MP, to facilitate comparison of it with the basic patterns MB.

If the color of the contours of the basic pattern MB is black, the operation of decolorizing may comprise converting the photograph received into a binary image (black and white, without intermediate grays). This can be accomplished, e.g., by converting the image into levels of gray (grayscale), then maximizing the contrast of the image (for example by the histogram equalization method), and then converting the image into black and white (through thresholding).

The step S2 also comprises an operation of identification, which consists of finding the correspondence between the personalized pattern MP and the basic pattern MB. Stated otherwise, the identification operation has as its aim to determine the identifier of the basic pattern MB.

The identification operation may be realized by correlation of the personalized patterns MP, then converting each “decolorized” rectangle into a finer canonical form (e.g. using a combination of the ZNCC method (in English, Zero Normalized Cross Correlation) and the ECC method (in English, Enhanced Correlation Coefficient Maximization), according to Evangelidis, G. D., and Psarakis, E. Z., 2008, (in English) “Parametric image alignment using enhanced correlation coefficient maximization”, in IEEE Transactions on Pattern Analysis and Machine Intelligence, Vol. 32 No. 10), then selecting the pattern which is closest to the expected pattern.

In addition, the step S2 comprises an operation of analysis, consisting of interpreting the difference between the personalized pattern MP and the basic pattern MB.

The operation of analysis comprises, e.g., the recognition of coloring applied to the basic pattern MB, and/or recognition and interpretation of a drawing added to the basic pattern MB, and/or recognition and interpretation of the modification of an element of the basic pattern MB.

This recognition of the coloring may further be accompanied by a modification of the coloring. This modification may consist of, e.g., transformation of a disjointed (non-solid) red coloring into a solid red coloring.

If the personalized pattern MP is not surrounded by a border, the operation of decolorization should be carried out first. Thus the step S2 comprises performance of the operation of decolorization, followed by operations of detection and identification (in parallel with each other), then followed by the operation of canonical forming (converting to canonical form), and then the operation of analysis.

If the personalized pattern MP is planar and is surrounded by a border, the operation of decolorization may be carried out later. The step S2 will then comprise the following operations, in sequence: the operation of detection, the operation of converting to canonical form (canonical forming), the operation of decolorization, the operation of identification, and the operation of analysis.

In this case, the operation of detection is preceded by an operation of detection of the border.

The term “detection of the border” is used to designate the operation of locating the position of the border in the photograph.

The detection of the border may be carried out with the aid of an approximation via polygons, followed by extraction of quadrilaterals.

Approximation via polygons comprises extraction of all of the contours of the binary image (e.g. via the method of Suzuki, S., and Abe, K., 1985, (in English) “Topological structural analysis of digitized binary images by border following”, CVGIP 30 1, 32-46), followed by identification of the polygons to which the forms defined by the various contours are most similar (e.g. employing the Ramer-Douglas-Peucker algorithm).

The extraction of the quadrilaterals comprises selection, from among the identified polygons, those which are convex and have four sides, then extraction of the quadrilaterals inscribed in the selected polygons, followed by converting the “decolorized” quadrilaterals to canonical form to obtain “decolorized rectangles” having the expected proportions of the pattern (e.g. by affine transformation, or “warping”).

If an identifier has been received, the proportions will be known.

If not, a basic proportion (e.g. square, 4:3 rectangle, etc.) is defined in advance, for all of the basic patterns MB which have been stored.

The use of a border makes it possible to improve the robustness of the step (step) of identification of the basic pattern MB. In particular, it is thus possible to correctly identify a basic pattern MB which has been colored with a color similar to the color of its contours (e.g. black).

If an identifier has been received, the operations of detection of the border and/or identification of the basic pattern MB are optional. For example, the system 1 may be configured to take into account a situation where the receipt of the identifier and the detection of the border suffice to identify the basic pattern MB. In a variant, the system 1 may be configured to verify that there is sufficient correspondence between the personalized pattern MP visible in the photograph and the basic pattern MB for which the identifier has been received.

In step S3, an animation film is generated from the personalized pattern MP from the associated basic pattern MB, and from a scenario comprising a pre-defined environment.

The term “scenario” refers to the pre-established development of an action, coupled with a set of rules setting forth the manner in which the personalization of a pattern influences, i.e. is reflected in, the animation film being generated.

One manner of reflecting a personalization of a pattern in an animation film may consist of what is called “texturing” (or “UV mapping”) of a three-dimensional model, using the personalized pattern for the texturing. The pre-defined environment may be a static or a dynamic environment. The environment is pre-defined by the creator or realizer; the environment facilitates the controlling of the scenario of the animation film.

The pre-defined environment is comprised of virtual elements which have been previously stored. The virtual elements are realized from synthetic images.

As an example, FIG. 4 illustrates a pre-defined environment comprised of a house 7 and a region of ground 8.

The pre-defined environment may also be comprised of real elements which have been previously stored, e.g. which are derived from a video. The real elements may comprise persons (e.g. models) who have been filmed in advance, and/or a room (e.g. a fashion show).

The animation film is comprised of a sequence of images (IL I2, . . . ) which are generated by combining, according to the pre-established scenario, the basic pattern MB, the elements of personalization which have been applied to it (e.g. the personalized pattern MP), and the pre-defined environment.

The images in the sequence of images may be mutually different or may be identical, depending on the scenario of the animation film. Consequently, depending on the type of the sequence of images and the type of the pre-defined environment, the animation film may be a “static film” or a “dynamic film”.

The number of images in the sequence is not limitative, and depends on the scenario.

The animation film which is generated depends in particular upon colors or textures applied to the basic pattern MB (e.g. coloring, painting, crafting, occlusion, etc.), and/or upon a drawing added to the basic pattern MB, and/or upon modification of an element of the basic pattern MB.

As an example, FIG. 5 illustrates a sequence of images from an animation film generated from the basic pattern MB according to FIG. 2, the personalized pattern MP according to FIG. 3, and the static environment according to FIG. 4. The sequence of images here comprises two images, I1 and I2.

For example, the system 1 may be configured so as to generate a first sequence of images if a box in the basic pattern MB is checked, and a second sequence of images if the box in the basic pattern MB is not checked.

According to another example, in which the basic pattern MB comprises a trampoline and a toboggan, the system 1 may configured so as to generate a first sequence of images if the trampoline is colored (a sequence showing a person using the trampoline), and a second sequence of images if the toboggan is colored (a sequence showing a person using the toboggan).

Thus, the elements of the basic patterns MB which are susceptible to being altered determine the choice of a scenario for the animation film from among a set of pre-established scenarios.

According to another example, if the personalized pattern MP is comprised of a drawing representing a closed form, added to the basic pattern MB, the sequence of images may related to passage through a course of a virtual automobile.

The sequence of images may also depend on a preceding iteration of steps S1 to S3.

As an example, consider receipt of a first personalized pattern MP corresponding to a first basic pattern MB representing a person, for coloring. During a first iteration of step S3, a first animation film is then generated from a sequence of images relating to a first set of movements of the colored person, in a first environment, e.g. a virtual environment representing a landscape.

Then, the system will receive a second personalized pattern MP corresponding to a second basic pattern MB representing a bird, for coloring. During a second iteration of step S3, a second animation film is then generated from a second sequence of images relating to a second set of movements of the person, combined with a set of movements (“displacements”) of the bird, in a second environment, e.g. a virtual environment representing a building.

FIG. 6 illustrates the steps of the method of generating a personalized animation film according to a second embodiment of the invention.

The method comprises the following:
a step S101 of receipt of a photograph;
a step S102 of association of a personalized pattern with a basic pattern; and
a step S103 of generation of an animation film.

In step S101, a photograph in digital form is received by the system 1.

The photograph displays a personalized pattern MP.

According to the second embodiment of the invention, the personalized pattern MP received does not cause a previously stored basic pattern MB to appear in the basic color of the contours. (The term “basic color” here means the color of the contours of the basic patterns MB.)

The step S101 comprises an operation consisting of receiving an identifier. The identifier received identifies a basic pattern MB to be associated with the personalized pattern MP which is visible in the view.

Here, the identifier should be received by the system 1 independently of the photograph.

In step S102, the personalized pattern MP is associated with the basic pattern MB corresponding to the identifier which was received.

Here, the basic pattern MB is identified from the identifier which was received.

Step S102 comprises an analysis operation, which may be realized using, as a photograph, the photograph resulting from the superposition of:
a copy (or trace) of the identified basic pattern MB and
the initial photograph.

In this case, the position of the personalized pattern MP in the image is predefined, because it is identical to the position of the copy (or trace). This superposition may be performed by manual, semi-automatic, or fully automatic adjustment, e.g. using “optical flow measurement” algorithms.

In step S103, an animation film is generated. Step S104 is similar to step S4 which was described above.

FIG. 7 illustrates a system 1 for generating a personalized animation film, according to another embodiment of the invention.

The system 1 may be used to implement the above-described method.

System 1 is comprised of receiving means 4 which are configured to receive a photograph in digital form. The photograph may display a personalized pattern.

System 1 is further comprised of means of association 5 which are configured to associate the personalized pattern with a basic pattern. The basic pattern is a part of a set of basic patterns which have been previously stored.

System 1 is also comprised of means of generation 6 of an animation film which are configured to generate an animation film from: the personalized pattern, the associated basic pattern, and a scenario comprised of a pre-defined environment.

The present invention is not limited to the embodiments described above through examples; rather, its scope extends to other variants.

1. A method of generating a personalized animation film, which method is carried out by informatic means; comprising:
(1) receiving a photograph, in digital form, displaying at least one personalized pattern;
(2) associating the at least one personalized pattern with a basic pattern which is part of a set of basic patterns which have been previously stored; and
(3) generating an animation film from the at least one personalized pattern, the associated basic pattern, and a scenario comprised of a pre-defined environment.

2. The method of generating a personalized animation film according to claim 1, wherein the at least one animation film is realized from a basic pattern from the set of basic patterns.

3. The method of generating a personalized animation film according to claim 1, wherein the pre-defined environment is comprised of virtual elements which have been previously stored.

4. The method of generating a personalized animation film according to claim 1, wherein step (2) comprises: (2.1) Identifying the basic pattern associated with the personalized pattern.

5. The method of generating a personalized animation film according to claim 4, comprising a step which comprises receiving at least one identifier of at least one basic pattern, to be associated with at least one personalized pattern which is visible in the view;
wherein the operation (2.1) is carried out from a subset of the set of basic patterns, which subset is determined using the at least one identifier which has been received.

6. The method of generating a personalized animation film according to claim 5, wherein the photograph shows at least one identifier.

7. The method of generating a personalized animation film according to claim 6, wherein the operation (2.1) comprises a sub-operation comprising detecting a border around the personalized pattern, wherewith the basic pattern is identified from the position of the border.

8. The method of generating a personalized animation film according to claim 1, wherein the animation film generated depends on a previous photograph which was used for a preceding iteration of steps (1) to (3).

9. An informatic program comprising instructions for carrying out the method according to claim 1, which program is executed by a processor.

10. A system for generating a personalized animation film, comprised of:
receiving means, configured to receive a photograph in digital form, which photograph displays at least one personalized pattern;
means for association, configured to associate the at least one personalized pattern with a basic pattern which is part of a set of basic patterns which have been previously stored; and
means for generating an animation film, configured to generate an animation film from: the at least one personalized pattern, the associated basic pattern, and a scenario comprised of a pre-defined environment.
